(19) United States
(12) Patent Application Publication
(10) Pub. No.: US 2015/0346106 A1
(43) Pub. Date: Dec. 3, 2015

(54) METHOD AND DEVICE FOR INSPECTING AND TAILORING A MOVING PRODUCT WEB

(71) Applicant: Texmag GmbH Vertriebsgesellschaft, Thalwil (CH)

(72) Inventors: ALFRED EDER, Biberbach (DE); ALEXANDER THOMALLA, Augsburg (DE); Stephan Pittino, Muenchen (DE)

(21) Appl. No.: 14/682,283

(22) Filed: Apr. 9, 2015

(30) Foreign Application Priority Data
Apr. 11, 2014 (DE) 10 2014 005 347.4

(51) Int. Cl. G01N 21/84; B65H 20/00

(52) U.S. Cl. CPC G01N 21/8422; B65H 20/00; G01N 2201/12

(57) ABSTRACT

In a method for inspecting and tailoring a predefined point of a moving product web (2), the moving product web (2) is located at least partly on a winder (3). Both a relative running length L of the product web (2) and an associated angle of rotation α of the winder (3) are captured. From these values, the absolute running length L_{TOT} of the moving product web (2) is then calculated. A camera (34) captures the moving product web (2). The camera value is compared with a reference value (36) and, together with the absolute running length L_{TOT} of the moving product web (2), is stored in a file (37). At a later time, with the aid of the file (37), the defective points of the moving product web (2) are moved to. The absolute running length L_{TOT} is determined again and compared with the file (37). Therefore, the defective points can easily be separated out from the moving product web (2).

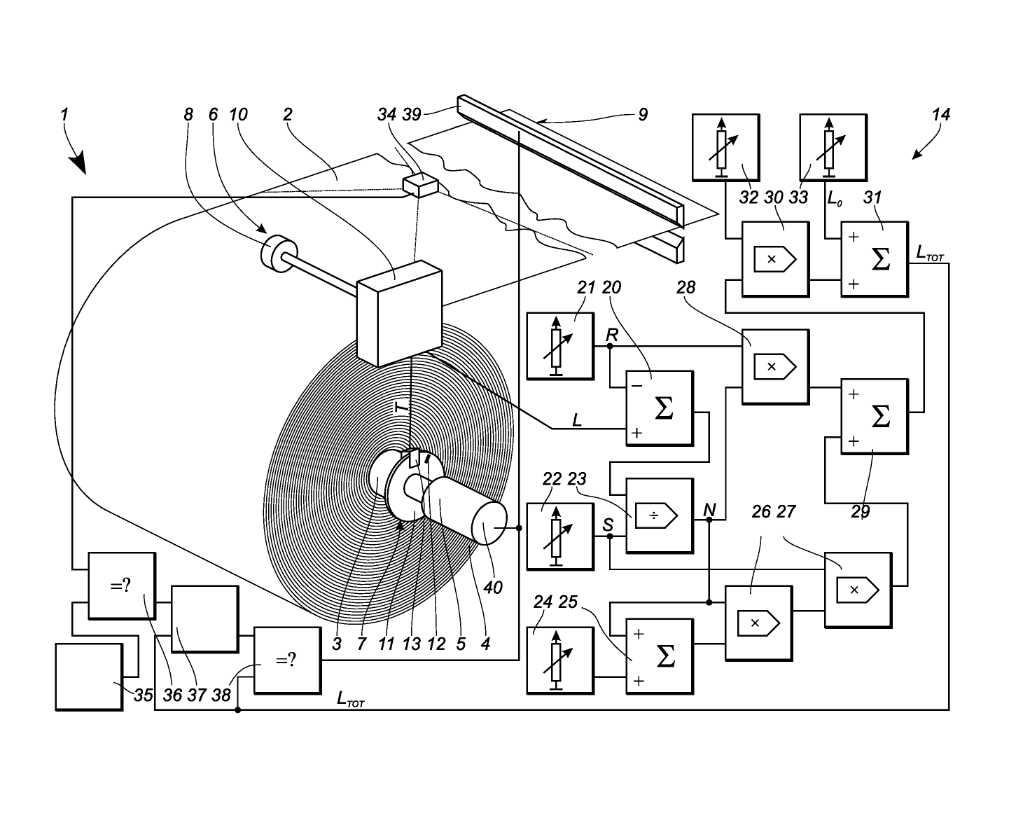

The present application claims priority to German Patent Application no:

DE 10 2014 005 347.4, filed Apr. 11, 2014

### FIELD OF THE INVENTION

The invention relates to a method for inspecting and tailoring a moving product web, the product web being located at least partly on a winder.

### DESCRIPTION OF THE PRIOR ART

During the inspection of a moving product web, defective points of the moving product web must be detected and stored in suitable form in order that it is possible to move to said points during the subsequent tailoring operation and to separate them out of the product web. In known inspection methods, this is done by marking the moving product web with appropriate markings, so that the absolute position of the defective points can be determined unambiguously. In the following tailoring operation, these markings must then be assessed. However, part of the product web is therefore needed for the markings, which thus generates additional waste. In addition, an additional application or printing unit may have to be set up for the markings, which is space-consuming and costly. It is therefore in principle desirable to carry the information about defective points of the moving product web not on the product web itself, but in a file assigned to the product web. However, an unambiguous assignment of the defective points determined in the inspection method to the respective section of the moving product web must be provided. To this end, it is necessary to determine the absolute running length of the moving product web.

It is known to determine the relative running length of a moving product web by means of a running wheel which is in contact with the product web. The relative running length of the product web can then be determined quite accurately from the number of revolutions of this running wheel and the known running wheel diameter. This is of considerable importance in particular in the area of printing presses, in order for example to determine the exact position of printed copies and to sever the product web exactly between two copies.

However, because of defective printed images, defective points of the product web or other sources of defects, various areas of the product web—in particular faulty products—have to be separated out again and again. For this task, however, the relative running length determination is inadequate. If, for example, material is cut out in an uncontrolled manner, consequential defects can no longer be placed exactly by using the relative running length determination. It would no longer be possible to reconstruct the position of the defects. Instead, it is necessary to determine the absolute running length, that is to say the distance of a predefined, current position of the moving product web, for example from a starting edge. Only in this way can the areas of the product web that are detected and queried as defective be separated out from the further process. In order to solve this problem, a code, which codes the running length, for example in multiples of the copy length, is usually applied to the product web. However, this measure in turn leads to additional wastage, since the code takes up part of the product web. Finally, it is quite unlikely that, in the case of a defective print, the running length code applied contemporaneously is correct and legible.

DE 10 2009 029 083 A1 discloses a generic method for inspecting a moving product web. Here, a fibrous web is wound up onto a wound roll and the roll diameter achieved in the process is measured without contact. In addition, the angle of rotation of the wound roll is measured, in order to determine the absolute position of the product web therefrom. By using this absolute position, defective points of the product web are cut out at a later time. This method has proven worthwhile in practice and forms the starting point of the present invention.

The invention is therefore based on the object of devising a method of the type mentioned at the beginning which permits inspection and tailoring of the moving product web without applying the marking and/or code. In addition, a device for carrying out this method is to be devised.

According to the invention, this object is achieved by the following features.

### BRIEF SUMMARY OF THE INVENTION

In a method for inspecting a moving product web, sections of the moving product web are captured by using at least one imaging method. Here, thought is given in particular to a camera. However, the inspection method is not restricted to cameras. At least one value obtained from the imaging method is compared with at least one reference value, and the result of the comparison is stored in at least one file. The at least one value obtained from the camera image is any desired variable derived from the camera image. For example, this value could be the position of an edge, the Fourier transformation of the camera image, a lightness or item of colour information averaged over a specific area of the product web, the grey value information of the individual pixels or else the original camera image itself. This enumeration is merely exemplary and not to be understood as final. The at least one reference value represents the desired magnitude of the at least one value and can be a scalar, vector or tensor value. In any case, the at least one reference value is chosen to match the at least one value. The comparison can contain tolerance variables such as relative displacements, rotations or the like. The comparison is used in particular to detect defective sections of the product web, in order to be able to move thereto at a later time and/or to be able to separate them from the production process. In order later to identify the defective section within the product web again and to move thereto, in addition the absolute running length of the product web is determined and, together with the result of the comparison, is stored in the at least one file. Since, in this way, the assignment of the result of the comparison to the respective sections of the product web is provided unambiguously, it is possible to dispense with a code or separate marking of the product web. Therefore, the entire product web can be used without producing additional rejects. In addition, no additional printing unit or the like has to be integrated into the production line for a possible application of a code or a reject mark. The inspection can therefore be handled substantially more flexibly and integrated more easily into existing production lines.

In order to capture the absolute running length of a predefined point of a moving product web, the relative running length of the moving product web is captured. At least part of the moving product web is wound up on a winder; in addition the angle of rotation of the winder assigned to the relative running length is captured. The term the “assignment” of two variables is to be understood here in such a way that, apart from possible proportionality functions and additive constants, both variables are captured for the same piece of web.

Therefore, both variables, that is to say the relative running length on the one hand and the angle of rotation of the winder on the other hand, refer to the same piece of web, so that the absolute running length of the product web can be calculated therefrom. Here, use is made of the fact that the running length of the moving product web during each revolution of the winder by a specific angle of rotation is greater the more layers are located on the winder. Therefore, from the knowledge of the relative running length and the angle of rotation of the winder that is associated therewith, the absolute running length, that is to say the current position based on a fixed reference variable of the product web, for example the web start, can be calculated without marks or codes provided on the moving product web.

In a method for tailoring the moving product web, apart from the fact that the product web has now been unwound, the absolute running length of the moving product web is determined in the same way as described above, and is compared with the running length values stored in the at least one file. In this way, the information as to which sections of the moving product web are defective can be recovered, in order to move thereto and/or to separate them out from the moving product web.

It transpires that the ratio between the relative running length of the product web and the associated angle of rotation, apart from an additive constant, is a linear function of the number of layers of the moving product web wound onto the winder. Therefore, the ratio of the relative running length and the associated angle of rotation are sufficient to determine the absolute running length of the product web therefrom.

For the simple technical implementation and in particular the reduction in the outlay on computation, it is advantageous if the relative running length of the product web is determined for a specific, predefined angle of rotation of the winder. Therefore, the angle of rotation which is assigned to the respectively measured running length is a predefined and therefore known constant. This therefore reduces the capture of the angle of rotation of the winder to the generation of a trigger signal, which is triggered at specific angles of rotation of the winder. This trigger signal starts and stops the measurement of the relative running length of the product web, so that the assignment of these measured values to the respective angle of rotation of the winder is already inherently satisfied.

A further simplification results if the predefined angle of rotation is an integer multiple of 2π, so that the relative running length is respectively determined for a complete revolution of the winder. In this way, it is sufficient to equip the winder with a single transmitter, which triggers a trigger during each revolution. By means of additional suppression of individual trigger signals, the predefined angle of rotation can also be set to a multiple of 2π.

In order to achieve a simple and therefore fast calculation of the absolute running length, it is advantageous if the number of layers N located on the winder is calculated in accordance with the following formula:

$$N = \frac{L \text{/} α - R}{S}$$

Here, R denotes the winder radius, S the thickness of the product web and L the measured relative running length for a rotation of the winder through the angle α in radians. In this way, the number of layers located on the winder can be calculated very simply, which then facilitates the calculation of the absolute running length. If necessary, the number N of layers located on the winder can also be interpreted directly as an absolute running length. However, because of the dependence of the relative running length on the number of layers N, this value is not metric, although this is tolerable in many cases.

If a metric determination of the absolute running length is necessary, then this can be calculated very simply by means of the following formula:

$${L}_{TOT} = α ( RN + S \frac{N ( N + 1 )}{2} ) + {L}_{0}$$

Here, L₀ denotes an arbitrary constant, which can be chosen freely. This calculation takes into account the fact that every further layer N contributes somewhat more to the absolute running length than the layer N−1 lying underneath. In this way, it is possible to state exactly where a specific position is located on the product web—for example in relation to the web start. For this purpose, neither a mark or code nor a relative running length capture is necessary. In the event of defects of no matter what type, the absolute running length can also be determined at any time in the middle of the process.

In order to carry out the method for inspecting a moving product web, a device which has at least one winder has proven worthwhile. Here, the product web is at least partly wound onto the at least one winder. In the at least one winder, at least one first transmitter determining the relative running length is arranged downstream. In addition, the at least one winder is assigned at least one second transmitter influenced by the rotation. The at least one first transmitter and the at least one second transmitter are operatively connected to at least one computing circuit, in order to determine the absolute running length at a predefined point of the moving product web. The said computing circuit outputs the absolute running length as a value, it being unimportant whether this value is represented in digital or analogue form. The device additionally has at least one camera, which captures the moving product web. At least one comparator compares at least one value captured from the image from the at least one camera with a reference value, in order to calculate from deviations a signal which indicates whether the point examined on the moving product web is defective or not. This signal, together with the determined absolute running length of the product web, is stored in an appropriate file, which is assigned to the product web. Therefore, without marking or coding the product web itself, by using this file it is possible to determine the location of defective points in the product web which can be moved to and/or separated out in a subsequent operation.

With regard to the capture of the absolute running length, the device for carrying out the method for tailoring a moving product web is formed in the same way as the device for carrying out the method for inspecting the moving product web. The camera and the comparator are superfluous in this device, however, since the file having the running length information about the defective points of the moving material web is already present and is assigned to the moving product web. This device has a further comparator, which compares the running length information from the file with the calculated absolute running length. In this way, it is determined when a defective point of the moving product web begins. This comparator is operatively connected to at least one drive and/or at least one severing device. Here, the at least one drive influences the speed of the moving product web, so that it is possible to move to defective points of the product web. Therefore, it is possible to move exactly to the start and/or the end of the defective points and, for example, to separate the latter out manually. The at least one drive can drive the winder, although this is not absolutely necessary. Alternatively or additionally, the signal from the comparator automatically triggers the severing operation, in order to separate the respective damaged area out of the moving product web.

Preferably, the at least one second transmitter is configured in such a way that it can generate at least one trigger signal, which controls the start and/or end of the running length capture of the at least one first transmitter. This not only simplifies the outlay in the computing circuit but permits a surprisingly simple structure of the sensors. Instead of a complicated rotary encoder, the at least one second transmitter can be implemented as a simple pulse generator, for example by means of a light barrier or a proximity switch.

The subject matter of the invention will be explained by way of example by using the drawing, without restricting the protective scope.

### BRIEF DESCRIPTION OF DRAWINGS

Other advantages and characteristics of this invention will be explained in the detailed description below with reference to the associated figures that contain several embodiments of this invention. It should however be understood, that the FIGURE is just used to illustrate the invention and does not limit the scope of protection of the invention.

The single FIGURE shows a three-dimensional basic illustration of a device with a computing circuit illustrated as a circuit diagram.

### DETAILED DESCRIPTION OF THE INVENTION

A device 1 is used both to inspect and to tailor a moving product web 2. In this case, the product web 2 is partly wound up onto a winder 3 and, on the latter, is arranged in various layers 4 over one another. The winder 3 is arranged such that it can be rotated about a shaft 5 and is thus driven in rotation by a drive. The shaft 5 can also be operatively connected to a drive 40 or a braking device, not illustrated, and can be designed to transmit torque. However, this is not imperative.

The winder 3 is operatively connected to a first transmitter 6 and a second transmitter 7. The first transmitter 6 has at least one running wheel 8, which is operatively connected to the product web 2 by a frictional connection. This running wheel 8 captures a relative running length L of the product web 2. This means that, although running path differences can be determined unambiguously and precisely by means of the running wheel 8, the absolute running length L_{TOT} beginning from a start 9 of the product web 2 or a suitable reference cannot be captured by using the first transmitter 6. The first transmitter 6 has a converter 10, which converts the movement of the product web 2 sensed by the running wheel 8 into an electric signal which corresponds to the relative running length L of the product web 2.

The second transmitter 7 has a disc 11 in which a slot 12 is provided. This disc 11 is sensed by a forked light barrier 13. This forked light barrier 13 generates a trigger T, which is fed to the converter 10 as a start-stop signal. Therefore, the first transmitter 6 always completes a running length measurement after a full revolution of the winder 3 and outputs the same as a relative running length L based on one revolution.

Connected downstream of the first transmitter 6 is a computing circuit 14, which will be explained in detail below. The signal from the relative running length L is fed to an adder 20 in a non-inverting manner. An adjustable value transmitter 21 is set to the winder radius R and is operatively connected to the adder 20 in an inverting manner. A further value transmitter 22 is set to a value which represents the thickness S of the product web 2. The value transmitter 22, together with the adder 20, is operatively connected to a divider 23. This divider 23 determines the number of layers N on the winder 3.

A third value transmitter 24, together with the divider 23, is operatively connected to a further adder 25 in a non-inverting manner. The third value transmitter 24 is set to a value which corresponds to one layer of the output signal from the divider 23. The divider 23 and the adder 25 are operatively connected to a multiplier 26.

The output of the latter, together with the value transmitter 22, is operatively connected to a further multiplier 27. The divider 23, together with the value transmitter 21, is operatively connected to a multiplier 28. Both multipliers 27, 28 feed an adder 29 in a non-inverting manner. An output signal from the adder 29 is operatively connected to a multiplier 30 and an adder 31. These are influenced by value transmitters 32, 33, which amplify the output signal from the adder 29 proportionally and apply a predefined offset.

An output signal L_{TOT} from the adder 31 then indicates the absolute running length L_{TOT} of the product web 2. In particular, no kind of marking or coding on the product web 2 is required for this purpose. The calculation of the absolute running length L_{TOT} is also independent of possible interference or errors, so that the determination of the absolute running length L_{TOT} is not dependent on the relative running length L being captured reliably and continuously by the first transmitter 6 from the start 9 of the product web 2.

To inspect the moving product web 2, a camera 34 which senses the product web 2 optically is provided. A value from the camera 34, together with a reference value 35, is fed to a comparator 36. This comparator 36 checks whether the deviations determined between the two lie within a predefined tolerance. In this case, the comparator 36 outputs an inactive output signal. If the differences lie outside the predefined tolerance range, the comparator 36 outputs an active output signal. Which actual differences between the value and the reference value 35 are intended to supply an inactive or active output signal depends on the respective application, it being possible for various types of defect also to be weighted differently. Thus, for example in the case of a structured product web, an offset of a repeating printed pattern plays virtually no part and can therefore be tolerated quite liberally. A disturbance in the printed pattern or colour errors are substantially less tolerable, however, since they impair the subsequent working processes considerably.

The output signal from the comparator 36, together with the absolute running length L_{TOT} that has been determined, is stored in a file 37, which is assigned uniquely to the moving product web 2.

In order to tailor the moving product web, the device is set in an unchanged way for absolute running length measurement. Instead of the camera 34 and the comparator 36, on the other hand, use is made of a comparator 38, which compares the file 37 already stored in the inspection method with the calculated running length L_{TOT}. Absolute running lengths which identify the start and end of defective points of the moving product web 2 are stored in the file 37. By comparing these stored running lengths with the currently calculated absolute running length L_{TOT} in the comparator 38, a signal which therefore indicates the start or the end of a defective point of the moving product web 2 is generated. This signal places the product web 2 correctly in relation to the severing device 39. For this purpose, the signal from the comparator 38 is fed to the drive 40 which, under the control of the signal, aligns the product web 2 such that the start and/or the end of the defective point is aligned correctly with respect to the severing device 39. Here, the drive 40 operates as a servo drive. In addition, the signal can also actuate the severing device 39 in order to remove defective points from the product web 2. Alternatively, the actuation of the severing device 39 or the cutting-out action can also be carried out manually.

Thought is given in particular to forming the device 1 in such a way that it contains only the components for the inspection or only the components for the tailoring since, as a rule, the inspection and tailoring operations have to be carried out at completely different times and at locations lying far apart. In this case, care must merely be taken that the file 37 remains assigned exactly to the respective moving product web 2 and is fed at the correct time to the device 1 for tailoring the moving product web 2.

Since some of the embodiments of this invention are not shown or described, it should be understood that a great number of changes and modifications of these embodiments is conceivable without departing from the rationale and scope of protection of the invention as defined by the claims.

### LIST OF REFERENCE SYMBOLS

1 Device
2 Product web
3 Winder
4 Layer
5 Shaft
6 First transmitter
7 Second transmitter
8 Running wheel
9 Start
10 Converter
11 Disc
12 Slot
13 Forked light barrier
14 Computing circuit
20 Adder
21 Value transmitter
22 Value transmitter
23 Divider
24 Value transmitter
25 Adder
26 Multiplier
27 Multiplier
28 Multiplier
29 Adder
30 Multiplier
31 Adder
32 Value transmitter
33 Value transmitter
34 Camera
35 Reference value
36 Comparator
37 File
38 Comparator
39 Severing device
40 Drive
L Relative running length
T Trigger
R Winder radius
N Number of layers
L_{TOT} Absolute running length

1. A method for inspecting a product web moving in a moving direction having sections being separated in said moving direction from each other by at least one position, said position having a relative running length L and an absolute running length L_{TOT}, the method further comprising a winder, having an angle of rotation α the method further comprising at least one value and at least one reference value and at least one file, said method comprising said moving product web is located at least partly on said winder, said sections being captured by using at least one imaging method, and said at least one value is obtained from said imaging method, said at least one value is compared with said at least one reference value, wherein a result of comparison is obtained, said absolute running length L_{TOT} of said position being calculated from a ratio between said relative running length L and said associated angle of rotation α of said winder, wherein said result of comparison together with said absolute running length L_{TOT}, is stored in said at least one file.

2. The method according to claim 1, wherein said angle of rotation α of said winder is a specific, predefined value.

3. The method according to claim 2, wherein an integer multiple of 2π, measured in radians, is chosen for said predefined angle of rotation α.

4. The method according to claim 3, wherein said winder comprises a number of layers N, said number of layers N is calculated in accordance with the following formula:
$$N = \frac{L \text{/} α - R}{S}$$
wherein said winder having a winder radius and R corresponds to said winder radius, said product web having a thickness and S corresponds to said thickness, and L corresponds to said measured relative running length L for a rotation of said winder through said angle of rotation α.

5. The method according to claim 4, wherein said absolute running length L_{TOT} of said product web is calculated from said number of layers N in accordance with the following formula:
$${L}_{TOT} = α ( RN + S \frac{N ( N + 1 )}{2} ) + {L}_{0}$$
wherein L₀ is an arbitrary constant.

6. A method for tailoring a product web moving in a moving direction having sections being separated in said moving direction from each other by at least one position, said position having a relative running length L and an absolute running length L_{TOT}, the method further comprising a winder, having an angle of rotation α the method further comprising at least one file, said file having a section indicator together with said position stored, said method comprising said moving product web is located at least partly on said winder, said absolute running length L_{TOT} of said position being calculated from a ratio between said relative running length L and said associated angle of rotation α of said winder, said absolute running length L_{TOT} being compared with said position stored in said file, wherein said sections of said product web being identified are at least one of, positioned and separated out from said moving product web.

7. The method according to claim 6, wherein said angle of rotation α of said winder is a specific, predefined value.

8. The method according to claim 7, wherein an integer multiple of 2π, measured in radians, is chosen for said predefined angle of rotation α.

9. The method according to claim 8, wherein said winder comprises a number of layers N, said number of layers N is calculated in accordance with the following formula:
$$N = \frac{L \text{/} α - R}{S}$$
wherein said winder having a winder radius and R corresponds to said winder radius, said product web having a thickness and S corresponds to said thickness, and L corresponds to said measured relative running length L for a rotation of said winder through said angle of rotation α.

10. The method according to claim 9, wherein said absolute running length L_{TOT} of said product web is calculated from said number of layers N in accordance with the following formula:
$${L}_{TOT} = α ( RN + S \frac{N ( N + 1 )}{2} ) + {L}_{0}$$
wherein L₀ is an arbitrary constant.

11. A device for inspecting a product web moving in a moving direction having sections being separated in said moving direction from each other by at least one position, said position having a relative running length L and an absolute running length L_{TOT}, a winder, having an angle of rotation, at least one value and at least one reference value and at least one file at least one first and second transmitter at least one computing circuit at least one comparator and at least one camera, said device comprising said product web can be at least partly wound on said winder, said sections being captured by said camera, and said at least one value is obtained from said camera, said at least one value is compared with said at least one reference value by said comparator, wherein a result of comparison is obtained, said absolute running length L_{TOT} of said section of said product web being calculated from a ratio between said relative running length L and said associated angle of rotation α of said winder, wherein said result of comparison together with said absolute running length L_{TOT}, is stored in said at least one file, said at least one first transmitter for determining said relative running length being arranged downstream of said winder said winder is assigned to said at least one second transmitter that is influenced by said rotation of said winder, wherein said at least one first transmitter and said at least one second transmitter are operatively connected to said at least one computing circuit in order to determine said absolute running length L_{TOT} of said position, and in said at least one file said result of comparison together with said calculated absolute running length L_{TOT} is stored.

12. The device according to claim 11, wherein said at least one second transmitter generates triggers T, which control at least one of a start and end of said running length capture of said at least one first transmitter.

13. A device for tailoring a product web moving in a moving direction having sections being separated in said moving direction from each other by at least one position, said position having a relative running length L and an absolute running length L_{TOT}, a winder, having an angle of rotation, at least one file at least one first and second transmitter at least one computing circuit and at least one comparator, said device comprising said product web can be at least partly wound on said winder, said file contains inspection indications together with associated absolute positions at said product web, said absolute running length L_{TOT} of said product web being calculated from a ratio between said relative running length L and said associated angle of rotation α of said winder, said at least one first transmitter for determining said relative running length L being arranged downstream of said winder said winder is assigned to said at least one second transmitter that is influenced by said rotation of said winder, wherein said at least one first transmitter and said at least one second transmitter are operatively connected to said at least one computing circuit in order to determine said absolute running length L_{TOT} of said moving product web, being compared with said absolute position stored in said file, wherein said sections of said product web being identified in said at least one file are at least one of, positioned and separated out from said moving product web.

14. The device according to claim 13, wherein said at least one second transmitter generates triggers T, which control at least one of a start and end of said running length capture of said at least one first transmitter.
